(19) United States
(12) Patent Application Publication
(10) Pub. No.: US 2002/0132906 A1
(43) Pub. Date: Sep. 19, 2002

(54) Conductive melt-processible fluoropolymer

(76) Inventors: Shosaku Kondo, Shimizu City (JP); Kasuke Ishii, Shimizu City (JP); Hajime Sato, Shimizu City (JP); Jeong Chang Lee, Shimizu City (JP)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/047,196

(22) Filed: Jan. 15, 2002

(30) Foreign Application Priority Data
Jan. 17, 2001 (JP) 2001-008045
Oct. 29, 2001 (JP) 2001-330324

(51) Int. Cl. C08K 3/04

(52) U.S. Cl. 524/496

(57) ABSTRACT

A method for producing a melt-processible fluoropolymer comprising pulverizing a composition of (a) carbon aggregate and (b) coagulum particles of aqueous dispersion polymerized melt-processible fluoropolymer, the pulverizing of said composition causing the disintegration of the aggregates and the coating of the coagulum particle with the disintegrated particles of carbon black, to obtain a uniform mixture of the carbon black in the fluoropolymer.

### FIELD OF THE INVENTION

This invention relates to melt-processible fluoropolymer rendered conductive by the incorporation of carbon black.

### BACKGROUND OF THE INVENTION

Fluoropolymers are used in containers and hoses for flammable fluids because they are little affected by such fluids and also are highly impermeable to them. Because the containers and hoses should have some electrical conductivity to prevent the accumulation of static charge, which can cause safety problems, fillers are added to the fluoropolymers to confer electrical conductivity. To obtain articles having uniform electrical conductivity, it is desirable that fillers that impart conductivity be uniformly distributed.

Japanese Kokai Patent Hei 11 (1999)-35694 discloses a method for granulation of melt-processible fluoropolymer by the addition of (polyfluoroalkyl)alkyl ether to aqueous fluorocarbon dispersion. The resultant fluoropolymer powder granules have a large average particle size (1.0 to 1.5 mm according to the Examples). Addition of conductive filler to these granules leads to uneven distribution of the filler and this adversely affects conductivity of articles melt-fabricated from the granule/filler mixture.

Japanese Kokai Patent 2000-103865 discloses a method to obtain an improved fluoropolymer powder. After melt-processible fluoropolymer obtained from the solution polymerization or suspension polymerization is coagulated and granulated, the granules are ground and heat-treated above the melting point of the polymer to melt at least some of particles thereby obtaining a fluoropolymer powder. The average particle size of the resultant fluoropolymer powder is as large as 0.5 to 5.0 mm, i.e. the grinding of these granules generally does not reduce the average particle size of the granules to less than 0.5 mm (500 μm). The grinding of fluoropolymer granules has the further disadvantage of being an expensive operation. Mixing of conductive filler with these ground granules yields compositions, which when melt-fabricated, give articles in which the conductive filler is not uniformly distributed.

There is a need for a process for improved mixing of fluoropolymer and carbon black to give a composition that can be melt-fabricated into articles having uniform conductivity.

### SUMMARY OF THE INVENTION

The present invention satisfies this need by the method for producing a uniform mixture of carbon black in melt-processible fluoropolymer, comprising pulverizing a composition comprising (a) said carbon black and (b) said melt-processible fluoropolymer, said carbon black in said composition being in the form of aggregates of primary particles and said melt-processible fluoropolymer in said composition being in the form of coagulum particles of aqueous dispersion polymerized melt-processible fluoropolymer, the pulverizing of said composition causing the disintegration of said aggregates and the coating of said coagulum particles with the disintegrated particles, thereby obtaining said uniform mixture.

In another embodiment, the present invention relates to a method for producing a melt-processible fluoropolymer powder having an average particle size of no more than 10 μm, comprising stirring an aqueous dispersion polymerization medium containing said fluoropolymer polymerized in said medium, said medium also containing electrolyte, to form a coagulum of said fluoropolymer, separating said coagulum from the resulting medium, drying said coagulum, and then pulverizing said dried coagulum together with carbon black having a primary particle size of no more than about 0.1 μm, and obtaining said powder as a uniform mixture of said carbon black in said fluoropolymer.

The resultant powder can be melt-fabricated into articles that have uniform electrical conductivity.

### DETAILED DESCRIPTION

In the present invention, the melt-processible fluoropolymer is made by aqueous dispersion polymerization, and typically contains from about 1 to about 75% fluoropolymer of submicron, i.e. less than about 1 μm, particle size. Preferably the polymer particles in the aqueous dispersion have an average size of less than about 0.5 μm, more preferably less than about 0.3 μm, most preferably from about 0.05 to about 0.2 μm, these being the primary particle sizes of the fluoropolymer.

Examples of the melt-processible fluoropolymer of this invention include copolymers of tetrafluoroethylene (TFE) with one or more perfluoro(alkyl vinyl ethers) (PAVE) such as perfluoro(methyl vinyl ether), perfluoro(ethyl vinyl ether), and perfluoro(propyl vinyl ether). These polymers are also known as PFA. Other examples are: copolymers of two or more perfluoroolefins such as a copolymer of TFE with hexafluoropropylene (FEP); a copolymer of TFE with hexafluoropropylene and PAVE; copolymers of perfluoroolefins with olefins such as TFE-ethylene copolymer (ETFE); a copolymer of chlorotrifluoroethylene with ethylene, and polyvinylidene fluoride (PVDF). Copolymers of TFE are preferred. In the TFE copolymers with perfluoro(alkyl vinyl ethers), perfluoro(ethyl vinyl ether) or perfluoro(propyl vinyl ether) is used preferably. The perfluoro(alkyl vinyl ether) content is 1-10 wt %, preferably 3-8 wt %.

The term “melt-processible” means that the copolymer can be processed (i.e., fabricated into shaped articles such as films, fibers, tubes, wire coatings and the like) by conventional melt-extruding means. Melt-processibility requires that the melt viscosity at the processing temperature be no more than about 10⁶ Pa·s. Preferably it is in the range of about 10² to 10⁶ Pa·s, and most preferably about 10³ to 10⁵ Pa·s.

The aqueous dispersion of melt-fabricable fluoropolymer is coagulated to form a coagulum of the fluoropolymer, typically by the addition of electrolyte to the aqueous medium and agitating the dispersion. Examples of electrolytes that can be used for coagulating the fluoropolymer dispersion are inorganic or organic compounds such as aqueous HCl, H₂SO₄, HNO₃, H₃PO₄, Na₂SO₄, MgCl₂, CaCl₂, sodium formate, potassium acetate, ammonium carbonate. Among them, compounds that become volatile in the later drying process of the melt-processible fluoropolymer coagulum particles, such as HCl, and HNO₃, are preferred.

These electrolytes are preferably used in the proportion of about 1 to about 15 wt % with respect to the weight of a melt-processible fluoropolymer in the aqueous dispersion, more preferably about 1.5 to about 10 wt %. To facilitate mixing, it is preferred that the electrolyte be added to the fluoropolymer dispersion as an aqueous solution. If the amount of the electrolyte used is too small, coagulation is slow and productivity suffers. If the amount used is too large, extra washing of the coagulated polymer is required.

Coagulation may be done in any vessel that is capable of agitation, the agitator preferably having a circumferential velocity (also called tip speed) of about 4 m/s or greater. Examples of effective shapes of the agitator blades include propeller, turbine, paddle, shell-type, horse-shoe, anchor, or spiral. The vessel should have drainage. Proper coagulation, to get the polymer to separate from the solution and float to the top, requires adequate agitation, which is generally provided by the agitator operating at a tip speed of about 4 m/s or greater, until separation is complete. With insufficient agitation coagulation is slow and separation of water from the polymer is difficult.

After draining aqueous medium from the coagulated polymer and washing with water as necessary, the fluoropolymer is dried at a temperature below its melting point. The dry coagulum particles thus obtained can be considered “pristine dried coagulum particles”. By pristine is meant that the particles are in their original or as-formed state and that they have not been subjected to size reduction or comminution and have not been granulated (agglomerated or pelletized) to larger particles.

The average particle size of the coagulum particles thus obtained is about 10 μm or less, but will typically be at least about 1 μm, and typically in the range of about 2 to 6 μm. The particles are made up of coagulated primary particles of the fluoropolymer. The use of coagulum particles, which by virtue of the coagulation process have an average particle size of no more than 10 μm, is an important feature of the present invention.

The melt-processible fluoropolymer powder thus obtained is combined with carbon black and the combination is mixed as will be further described below. Conductive carbon blacks such as ketjen black, acetylene black, oil furnace black, thermal black and channel black are preferred, while ketjen black and acetylene black having average primary particle size of about 0.1 μm or less is more preferred. If the particle size of the carbon black used is larger than about 0.1 μm, segregation of carbon black occurs easily during melt processing and uniform surface resistivity is difficult to obtain. For making extruded articles with good surface smoothness, using acetylene black with low impurity content is preferred. Where low surface resistivity is more important, ketjen black is preferred. Allowance must be made for the higher impurity content of ketjen black compared to acetylene black and the resulting reduced surface smoothness.

Though the preferred carbon blacks preferably have a primary particle size of less than about 0.1 μm, the carbon blacks exist as aggregates of primary particles of greater than about 1 μm in average size and usually greater than about 2 μm, and these aggregates aggregate further to form larger aggregates.

The amount of carbon black compounded depends on the desired conductivity. Carbon black is compounded in such amount that the composition of article obtained from the melt processible fluoropolymer powder produced with the mixing process should have a surface resistivity of 10¹⁶ Ω or lower, preferably 10¹⁴ Ω or lower. Preferably, the conductive carbon black content in the compositions being subject to the mixing process and thus in the resultant uniform mixture, should be about 1-15 wt %, more preferably about 1-10 wt %, and even more preferably about 4 to 10 wt %, based upon composition weight, i.e. weight of fluoropolymer plus weight of carbon black.

In addition to carbon black, other additives may be included in the composition. Examples are powder or fibrous glass, graphite, alumina, mica, silicon carbide, boron nitride, titanium oxide, bismuth oxide, iron oxide, bronze, gold, silver, copper, nickel, stainless steel or molybdenum disulfide.

In the present invention, the apparatus for mixing the conductive carbon black and the melt-processible fluoropolymer coagulum particles of average diameter of 10 μm or smaller is a cutter-mixer having sharp blades that can be rotated at high speed. This is another important feature of the present invention, i.e. the mixing involves pulverizing the composition, which results in the formation of a uniform mixture of the carbon black and fluoropolymer components. In the high speed cutter-mixers blade rotation of about 2000 rpm or greater, or peripheral speed, i.e. tip speed, which is the speed of the outermost point of the rotating element, of about 50 m/sec or higher is preferred. More preferred is rotation of about 3000-20000 rpm or peripheral speed of about 70-115 m/sec. The average size of the particles of the resultant uniform mixture according to this invention is not less than about 10% of the average size of the melt-processible fluoropolymer powder (coagulum particles), preferably not less than about 20% of the average size of the melt-processible fluoropolymer powder, more preferably not less than about 50% of the average size of the melt-processible fluoropolymer powder, and most preferably not less than about 70% of the average size of the melt-processible fluoropolymer powder in the mixture prior to this pulverizing.

The cutter-mixer (pulverizing process) has more of a particle size reduction effect on the carbon black aggregates than on the fluoropolymer coagulum particles, i.e. the cutter mixer disintegrates the carbon black aggregates, reducing them to smaller aggregates of carbon black primary particles preferably having an average particle size of no greater than about 1 μm. The cutter mixer causes the disintegrated carbon black particles (smaller aggregates) to coat the fluoropolymer coagulum particles. This coating is in the form of carbon black particles clustered around each coagulum particle. It is believed that the carbon black particles are at least in part fused and/or embedded in the fluoropolymer coagulum particles, i.e. more than simply physically mixed with the coagulum particles. Compositions of fluoropolymer and carbon black made according to this invention do not separate significantly into the fluoropolymer and carbon components when shaken. The resultant uniform mixture of fluoropolymer and carbon black exiting the cutter-mixer is hot, but not so hot as to cause melting of the fluoropolymer, e.g. the temperature of the uniform mixture is in the range of about 125 to 225° C., caused by the pulverizing action of the cutter-mixer. The heating up of the composition during the pulverizing process apparently causes the coating of the coagulum particles with the carbon black particles. The coating of the small coagulum particles with the even smaller carbon black particles resulting from the pulverizing process provides articles which, when melt fabricated from this composition exhibit uniform electrical conductivity. Thus the uniformity of the carbon black/fluoropolymer mixture is indicated by the uniform electrical conductivity, conveniently measured as electrical resistivity, of articles melt-fabricated from the mixture.

If it is desired to use the composition of this invention as a concentrate that can be made and then later melt-blended with other fluoropolymer and molded in to articles having uniform resistivity and smooth surfaces, a greater amount of carbon black than 1-15 wt % based on the composition weight can be mixed with the dried coagulated fluoropolymer particles.

The melt-processible fluoropolymer powder composition obtained with the above-mentioned pulverizing/mixing is preferably recovered with a cyclone or bag filter as it is cooled to room temperature. By doing this, a melt-processible fluoropolymer powder having about 10 μm or less in average particle size, preferably about 1 to 10 μm and more preferably about 2 to 6 μm, suitable for producing extruded articles with uniform electrical conductivity is obtained. Because of the small particle size of the disintegrated carbon black aggregates relative to the particle size of the fluoropolymer coagulum particles, the particle size of the pulverized mixture will be about the same as that of the coagulum particles. Thus the coagulum particle size reduction described above applies to the pulverized composition (uniform mixture) as well, i.e. the pulverized composition particle size can be the same as or less than the starting coagulum particle size in accordance with the percentages described above with respect to the coagulum particles.

Such fluoropolymer powder compositions (uniform mixture) may be pelletized by usual melt extruders then melt-processed by extrusion, injection molding, transfer molding, melt spinning, etc. It is also possible to use the conductive fluoropolymer powder compositions obtained from the pulverizing process directly without pelletization as melt-processing raw materials or after compacting for easy feeding through the extruder hopper without bridging. The fluoropolymer powders of the present invention may be granulated and used for powder molding or coating materials.

The composition is suitable for various types of articles such as hoses, tubes and containers for transporting flammable fluids where prevention of accumulation of static electricity is desirable, or for the fixing roll surface of copy machines where control of conductivity is necessary. Besides these applications where electrical conductivity is important, the powder composition is suitable also for tubes, vessels, etc. that need good thermal conductivity.

### EXAMPLES

The present invention is illustrated in the following examples. The tetrafluoroethylene-perfluoro(alkyl vinyl ether) copolymer (PFA) used is tetrafluoroethylene-perfluoro(propyl vinyl ether) copolymer (TFE/PPVE, hereinafter referred to as PFA-C3, melting point 309° C., PPVE content=3.5 wt %) or tetrafluoroethylene-perfluoro(ethyl vinyl ether) (PEVE, hereinafter referred to as PFA-C2, melting point 290° C., PEVE content=7.1 wt %). The average particle diameter of the melt-processible fluoropolymer coagulum particles and the conductive fluoropolymer powder composition obtained by the process of the present invention, and the surface smoothness and surface resistivity of articles (thin tubes) extruded from the powder compositions are determined by the methods described below.

(a) Average particle diameter: The average particle diameter of the melt-processible fluoropolymer coagulum particles and the conductive fluoropolymer powder compositions obtained by the process of the present invention is measured using a laser diffraction particle size distribution measurement apparatus from Helos & Rodos, Sympatec GmbH, Germany.

(b): Surface smoothness: Conductive melt-processible fluoropolymer powder composition from the cutter-mixer described in Example 1 is extruded at 370° C. and 20 rpm using a twin-screw extruder (Laboplastmill 30C150, Toyo Seiki Seisakusho) for pelletizing and made into a tube of thickness 50 μm and inner diameter 40 mm using a 30 mm uniaxial extruder. The tube surface smoothness is measured using a contact needle surface roughness measurement apparatus (Surfcom 575A-3D, product of Tokyo Seimitu). Measurements are made at five randomly chosen positions, and the average value is reported as surface smoothness.

(c) Surface resistivity: Resistivity is the reciprocal of conductivity and is measured as described here. The HR probe of the surface resistivity measurement apparatus (HIRESTA IP) of Mitsubishi Yuka Co. is contacted with the surface of the above tube, and 10 V (DC) is applied for 10 sec, and the value shown in the indicator is reported as the surface resistivity in ohms (Q) (see JIS K6911 or ASTM D 257). Measurements are made at five randomly chosen positions, and average, minimum, and maximum values are reported. By uniform surface resistivity is meant that the maximum surface resistivity value divided by the minimum surface resistivity value gives a quotient of less than about 100, preferably less than about 50, more preferably less than about 20, and most preferably about 10 or less.

### Example 1

Sixty kg of 30 wt % aqueous PFA-C3 dispersion (average particle size 0.2 μm) obtained from the emulsion polymerization is charged to a kettle (100 L) equipped with a stirring shaft with a 6-bladed down flow propeller and drainage, and 500 g of 60% nitric acid is added with stirring at 300 rpm (peripheral speed 4.7 m/s), followed by further stirring at 300 rpm for 10 min to coagulate the aqueous dispersion then at 450 rpm (peripheral speed 7.1 m/s) for 20 min to allow coagulum particles to rise to the surface of the aqueous polymerization medium and to separate from the liquid. The liquid is discharged from the stirring kettle. Then water is added to wash coagulum particles. The particles are then dried at 160° C. for 24 hr to obtain PFA-C3 coagulum particles. The size of the PFA-C3 coagulum particles is measured by the laser diffraction particle size distribution measurement apparatus. The average particle diameter is 6 μm.

Fourteen kg of the coagulum particles and 1 kg of acetylene black aggregates (F-35X made by Denki Kagaku Kogyo (Inc.), average particle size 0.025 μm) are charged to the cutter-mixer (AC-200S made by Aikosha Seisakusho) at room temperature, and pulverized at 3600 rpm (peripheral speed 75.3 m/s) for 15 min to obtain a uniform mixture powder composition of the present invention in which coagulum particles of PFA are coated with carbon black particles. This powder composition is measured for the average particle size by the same apparatus used above. Results are summarized in the Table.

The powder composition obtained is pelletized with a twin screw extruder (made by Toyo Seiki Seisakusho) and melt-extruded to make tubing of 50 μm in thickness and 40 mm in inside diameter. Properties of the tube are summarized in the Table.

### Example 2

PFA-C3 coagulation powder and pulverized powder composition of the present invention are prepared as described in Example 1 by using 0.5 kg of ketjen black (ketjen black EC) in place of the acetylene black and made into a tube. The amount is reduced to 0.5 kg because the ketjen black has much more developed structure than the acetylene black. Results are summarized in the Table.

### Example 3

According to the method of Example 1, 60 kg of a 30 wt % PFA-C2 fluoropolymer aqueous dispersion (average particle diameter 0.1 μm) obtained by emulsion polymerization is coagulated and dried to obtain a PFA-C2 coagulation fine powder (coagulum particles). The coagulum powder thus obtained is measured by laser diffraction particle size distribution measurement apparatus. The average particle diameter is 5.8 μm. Using the cutter-mixer and the mixing conditions of Example 1, 14 kg of the PFA-C2 coagulum particles and 1.0 kg of acetylene black aggregates are mixed as in Example 1 to obtain another conductive fluoropolymer powder composition of the present invention. This particle size of this conductive fluoropolymer powder is measured by the above particle size distribution measurement apparatus. Results are summarized in the Table. As in Example 1, the conductive fluoropolymer powder is pelletized and made into a tube. Properties of the tube obtained are summarized in the Table.

### Comparative Example 1

Fluoropolymer coagulum particles and powder composition are prepared as in Example 1 but with solvent granulation using 10 kg of 1,1,1,2,3,4,4,5,5,5-decafluoropentane after addition of 500 g of 60% nitric acid to form large granules of the coagulated fluoropolymer. The coagulum particles and carbon black aggregates are mixed as in Example 1. Tubing is extruded using the resulting mixture and measured for surface resistivity and surface smoothness. Results are summarized in the Table.

### Comparative Example 2

Fluoropolymer coagulum particles made according to the teaching of this invention and acetylene black are combined as described in Example 1 except that a Henshel mixer is used. The Henshel mixer has a rotating blade for mixing but not cutting that is not for particle size reduction on the scale necessary for the method of this invention. The resulting mixture is extrusion molded to form a tube. The tube is found to have surface resistivity is more than 10⁶ Ω greater than that for the composition of Example 1, indicating poor dispersion of carbon black in the fluoropolymer. The tube has poor surface smoothness that is also the result of poor dispersion of carbon black. Nonuniform dispersion causes nonuniform viscosity in the molten polymer. At high local concentrations of carbon black, the melt viscosity is high. These high viscosity regions contribute to surface roughness.

### Summary of Examples

As shown in the Table, the conductive fluoropolymer powder compositions (Examples 1-3) obtained according to the method of the present invention by pulverization/mixing of the melt-processible fluoropolymer coagulum particles of average particle diameter 10 μm or less with carbon black aggregates in a cutter-mixer provide a uniform mixture of carbon black and the heat-meltable fluoropolymer coagulum particles in which the carbon black coats the coagulum particles. In these Examples, the temperature of the uniform mixture exiting the cutter-mixer is about 150 to 200° C. The articles (tubes) melt-fabricated this conductive fluoropolymer powder have uniform surface resistivity regardless of where the resistivity measurement is made. The tube of Example 2, in which ketjen black rather than acetylene black is used is inferior in surface smoothness, due to impurities in ketjen black. The tubes of Examples 1 and 3, in which acetylene black is used, exhibit excellent surface smoothness, much better than that exhibited by Comparative Example 1, in which the fluoropolymer is granulated to a large particle size prior to the pulverizing/mixing step.

The conductive fluoropolymer powder composition (Comparative Example 1) obtained by pulverization and mixing in a cutter-mixer of the PFA coagulation powder of average particle diameter 220 μm obtained by solvent granulation, in place of the melt-processible fluoropolymer coagulum particles of average particle diameter 10 μm or below obtained by the method of the present invention contains large PFA particles, thus even after pulverization and mixing in a cutter-mixer, the conductive fluoropolymer powder composition still has large particle diameter with poor carbon black dispersion, resulting in increased and nonuniform surface resistivity of the extruded tube.

Accordingly, it is demonstrated that using the melt-processible fluoropolymer coagulum particles that have an average particle size of 10 μm or less is preferred.

TABLE

| | | | | | Comp. |
|---|---|---|---|---|---|
| | | Ex. 1 | Ex. 2 | Ex. 3 | Ex. 1 |
| Raw | PFA-C3 (kg) | 14 | 14 | — | 14 |
| material | PFA-C2 (kg) | — | — | 14 | — |
| | Acetylene black (kg) | 1.0 | — | 1.0 | 1.0 |
| | Ketjenblack (kg) | — | 0.5 | — | — |
| | Average particle diameter | 6.0 | 6.0 | 5.8 | 220 |
| | of PFA fine particles | | | | |
| | (μm) | | | | |
| Average particle diameter of mixed | | 4.5 | 6.0 | 5.8 | 15.2 |
| powder (μm) | | | | | |
| Tube | Surface smoothness (μm) | 0.11 | 0.37 | 0.10 | 0.26 |
| properties | Surface resistivity Ω | × 10⁵ | × 10⁴ | × 10⁶ | × 10⁹ |
| | Average | 9.5 | 4.5 | 4.5 | 6.5 |
| | Minimum | 3.5 | 1.3 | 2.3 | 3.2 |
| | Maximum | 15.8 | 14.1 | 8.9 | 1260 |
| | Max/Min | 4.5 | 10 | 3.9 | 400 |

What is claimed is:

1. A method for producing a uniform mixture of carbon black in melt-processible fluoropolymer, comprising pulverizing a composition comprising (a) said carbon black and (b) said melt-processible fluoropolymer, said carbon black in said composition being in the form of aggregates of primary particles and said melt-processible fluoropolymer in said composition being in the form of coagulum particles of aqueous dispersion polymerized melt-processible fluoropolymer, the pulverizing of said composition causing the disintegration of said aggregates and the coating of said coagulum particles with the disintegrated particles, thereby obtaining said uniform mixture.

2. The method for producing the uniform mixture of claim 1 in which said melt-processible fluoropolymer is a polymer or copolymer of monomers chosen from tetrafluoroethylene, hexafluoropropylene, perfluoro(alkyl vinyl ether), vinylidene fluoride and vinyl fluoride.

3. The method for producing the uniform mixture of claim 1 in which said coagulum has an average particle size of no more than about 10 μm.

4. The method for producing the uniform mixture of claim 1 in which said uniform mixture is in the form of a powder having an average particle size of about 2 to 10 μm.

5. The method of producing the uniform mixture of claim 1 wherein the amount of carbon black in said composition is 1 to 15 wt % based on the total weight of said fluoropolymer and said carbon black.

6. The method of producing the uniform mixture of claim 1 wherein said coagulum particles are formed by agitation of said aqueous dispersion, followed by separation of said coagulum particles from the aqueous medium of said aqueous dispersion and drying and additionally carrying out said agitation in the presence of electrolyte added to said aqueous dispersion.

7. The method of producing the uniform mixture of claim 1 wherein said pulverizing causes greater disintegration of said aggregates than said of coagulum particles.

8. The method of producing the uniform mixture of claim 1 wherein said aggregates have an average particle size of greater than about 1 μm.

9. The method of producing the uniform mixture of claim 1 wherein said pulverizing causes said composition to heat up to a temperature in the range of about 125 to 225° C. during said pulverizing.

10. A method for producing a melt-processible fluoropolymer powder having an average particle size of no more than about 10 μm, comprising stirring an aqueous dispersion polymerization medium containing said fluoropolymer polymerized in said medium, said medium also containing electrolyte, to form a coagulum of said fluoropolymer, separating said coagulum from the resulting medium, drying said coagulum, and then pulverizing said dried coagulum together with carbon black having a primary particle size of no more than about 0.1 μm, and obtaining said powder as a uniform mixture of said carbon black in said fluoropolymer.

11. The powder of claim 4.

12. Melt fabricated pellets of the powder of claim 11.

13. Melt-processible fluoropolymer powder comprising coagulum particles of said melt-processible fluoropolymer having an average particle size of about 1 to 10 μm coated with particles of carbon black.

14. The melt-processible fluoropolymer powder of claim 13, wherein said particles of carbon black are disintegrated aggregates of carbon black.

15. The melt-processible fluoropolymer powder of claim 13, wherein the average particle size of said coagulum is about 2 to 6 μm.
